(19) United States
(12) Patent Application Publication
(10) Pub. No.: US 2007/0019569 A1
(43) Pub. Date: Jan. 25, 2007

(54) Methods for automatically selecting a cluster header in a wireless sensor network and for dynamically configuring secure wireless sensor network

(76) Inventors: Il Gon Park, Seoul (KR); Young Sam Shin, Seo-gu (KR); Jin Won Kim, Yuseong-gu (KR); Hee Seok Choi, Yuseong-gu (KR); Seung Min Park, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/409,673

(22) Filed: Apr. 24, 2006

(30) Foreign Application Priority Data
Jul. 22, 2005 (KR) 10-2005-0066850

(51) Int. Cl. H04L 12/28; H04L 12/56

(52) U.S. Cl. 370/254; 370/400

(57) ABSTRACT

Provided are methods for automatically selecting a cluster header to dynamically configure a wireless sensor network, and encoding and sending a packet between nodes in a wireless sensor network to secure communication. The method includes: broadcasting, at each normal node, cluster header selecting information including capability information of the normal node, identification information of a cluster including the normal node, and identification information of the normal node, to neighboring nodes; and judging, at each normal node, if the normal node will be selected as a cluster header using the cluster header selecting information received from at least one neighboring node.

### CROSS-REFERENCE TO RELATED APPLICATION

This application claims priority to and the benefit of Korean Patent Application No. 2005-66850, filed Jul. 22, 2005, the disclosure of which is incorporated herein by reference in its entirety.

### BACKGROUND

1. Field of the Invention

The present invention relates to methods for automatically selecting a cluster header to dynamically configure a wireless sensor network, and encoding and sending a packet between nodes in a wireless sensor network to secure communication.

2. Discussion of Related Art

A wireless sensor network is used to collect various information using a sensor node capable of wireless communication. The wireless sensor network is applied in various fields and its use will tremendously increase. For example, in the Ubiquitous Age, electronic tags will be attached to everything to recognize things and the environment, and real time information will be configured and utilized through a sensor network. Basically, a wireless sensor network may comprise at least one normal node group (cluster) including a plurality of normal nodes which collect information about the physical environment around a node, a sink node applying and processing the environmental information collected by the normal nodes such that it can be easily understood, and a cluster header (node) performing direct communication among the normal nodes and the sink node.

Conventionally, an engineer designing a network decided a cluster header manually or using a clustering algorithm. However, the former method has drawbacks of considerable time loss, cost increase, and difficulty in maintenance. According to the latter method, the nodes neighboring the cluster header send and receive messages and thereby form a cluster. In this case, since most clusters are formed by one-hop distance, a radius of the cluster is restricted due to radio frequency (RF) characteristics. In addition, the cluster header is frequently changed since a network connection is frequently changed.

Meanwhile, a wireless sensor network system is exposed to an open environment and has security vulnerabilities due to characteristics of a node having limited resources. Therefore, there is need for a wireless sensor network system that allows encrypted communication without applying a load to the network.

### SUMMARY OF THE INVENTION

The present invention provides methods for automatically selecting a cluster header to dynamically configure a wireless sensor network, and encoding and sending a packet between nodes in a wireless sensor network to secure communication.

One aspect of the present invention provides a method for selecting a cluster header from a node cluster including at least one normal node. The method comprises: broadcasting, at each normal node, cluster header selecting information including capability information of the normal node, identification information of a cluster including the normal node, and identification information of the normal node, to neighboring nodes; and judging, at each normal node, if the normal node will be selected as a cluster header using the cluster header selecting information received from at least one neighboring node.

Another aspect of the present invention provides a method for configuring a wireless sensor network system, comprising: (a) selecting a cluster header from a node cluster including at least one normal node; (b) sending a cluster header confirmation request signal including capability information of the cluster header and a randomly selected first value from the cluster header to a sink node; (c) sending a cluster header acknowledgement signal and the first value from the sink node to the cluster header; (d) sending a beacon signal from the cluster header to the normal node; (e) sending an association request signal including an identification value of the normal node and a randomly selected second value from the normal node to the cluster header; and (f) sending an association acknowledgement signal and the second value from the cluster header to the normal node.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 illustrates the structure of a wireless sensor network system to which the present invention is applied;

FIG. 2 shows a data format of a cluster header payload data unit (CPDU) used for automatically selecting a cluster header in a wireless sensor network according to an exemplary embodiment of the present invention;

FIG. 3 is a flowchart of a process of automatically selecting a cluster header from normal nodes included in a normal node cluster according to an exemplary embodiment of the present invention;

FIG. 4 shows a process of configuring a sensor network after a cluster header is selected according to an exemplary embodiment of the present invention;

FIG. 5 shows an encrypted communication method between a normal node and a cluster header according to an exemplary embodiment of the present invention;

FIG. 6 shows an encrypted communication method between cluster headers according to an exemplary embodiment of the present invention; and

FIG. 7 shows an encrypted communication method between a cluster header and a sink node according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

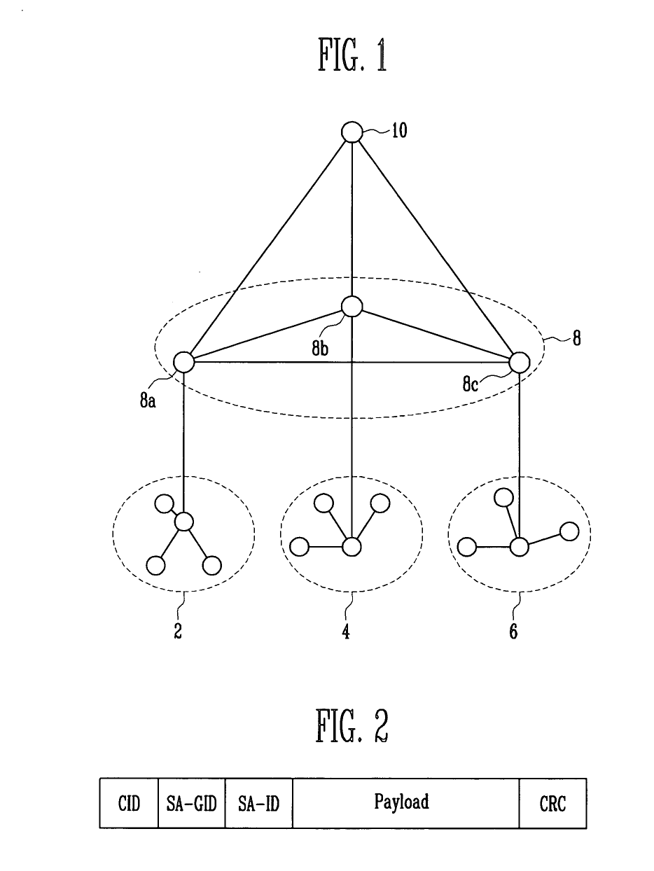

FIG. 1 conceptually illustrates the structure of a wireless sensor network system to which the present invention is applied. The wireless sensor network system can be connected with a heterogeneous network such as a transmission control protocol (TCP)/internet protocol (IP) network. Referring to FIG. 1, the wireless sensor network system comprises a level of normal node clusters 2, 4, and 6, a level 8 of cluster headers 8a, 8b, and 8c, and level of a sink node 10.

Each of the normal node clusters 2, 4, and 6 includes at least one normal node having the same or similar sensing functions. The normal node includes a sensor node detecting the surrounding environment (monitoring temperature, humidity, movement, sound, light, or whether something is present or not), an actuator node for driving a specific device, and/or a smart tag for receiving location information and providing a ubiquitous service.

Such normal nodes are classified into the normal node clusters (groups) 2, 4, and 6 according to their functions, and managed. For example, normal nodes checking temperature may be included in a first normal node group 2 and managed, normal nodes checking humidity may be included in a second normal node group 4 and managed, and normal nodes checking movement may be included in a third normal node group 6 and managed. Thus, normal nodes are grouped and managed according to their functions, in the present invention.

The sink node 10 level is connected to a device having plenty of resources such as a desktop personal computer (PC), and manages the topology of the entire sensor network, a security element, and so forth. And, the sink node 10 is supplied with various sensed information from the normal node clusters 2, 4, and 6, and manages the information.

The cluster headers 8a to 8c are nodes representing the normal node clusters 2, 4, and 6 in a lower part, manage the normal nodes in the lower part, provide information required for sensor network communication to the normal nodes, and play the role of a medium of direct/indirect message communication between the sink node 10 and normal nodes. In FIG. 1, one cluster header corresponds to one cluster but, according to the present invention, one or more cluster header can be selected as the occasion demands.

According to the present invention, at least one cluster header is automatically selected from the normal nodes included in each of the normal node clusters 2, 4, and 6. For example, when a cluster header of the first normal node cluster 2 runs out of energy or malfunctions, another cluster header is automatically selected from normal nodes included in the first normal node cluster 2. In other words, according to the present invention, a cluster header is automatically selected in the wireless sensor network without manual manipulation.

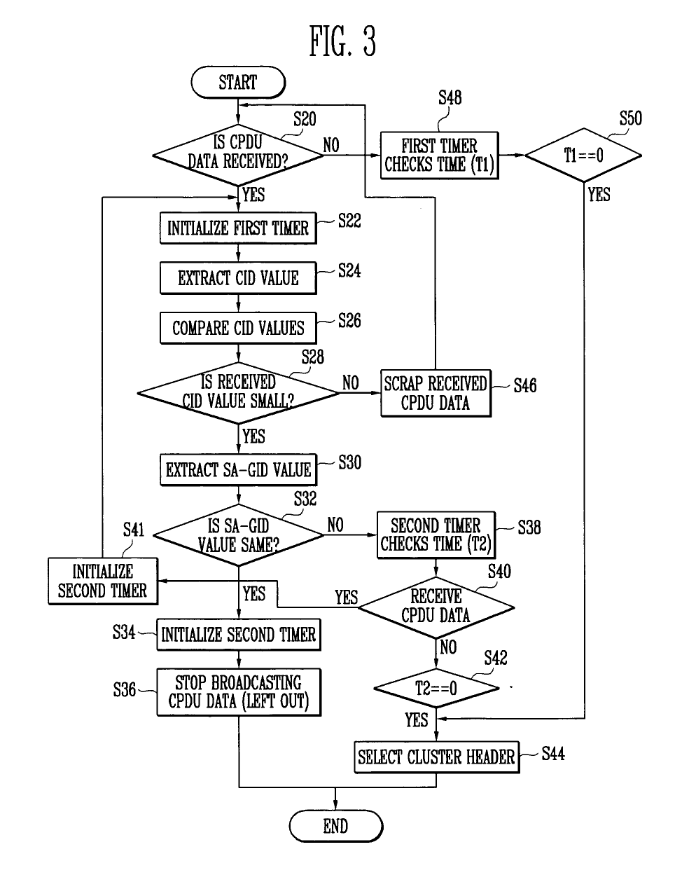

FIG. 2 shows a data format of a cluster header payload data unit (CPDU) used for automatically selecting a cluster header in a wireless sensor network according to an exemplary embodiment of the present invention. Referring to FIG. 2, the CPDU for selecting a cluster header comprises areas for storing a cluster header identifier (CID), a sensor attribute-group identifier (SA-GID), a sensor attribute-identifier (SA-ID), a payload (or data), and a cyclic redundancy check (CRC) (or an error code).

The CID is capability information of a normal node, which is a standard of judgment for selecting a cluster header, and is set up according to a standard determined by a manager before the CID is given to the sensor network. As a matter of fact, the CID is determined by the manager based on the remaining amount of energy, e.g., the remaining amount of energy in a battery, hardware capability, and/or an energy consumption amount, and is given only to a node which can perform the function of a cluster header. For example, the manager may give a low CID value to a normal node having a large remaining amount of energy, and a high CID value to a normal node having a small remaining amount of energy. In addition, the manager may give a low CID value to a normal node having high hardware capability, and a high CID value to a normal node having low hardware capability. In addition, the manager may assign CID values in consideration of all of remaining energy, hardware capability, energy consumption, and so forth. Hereinafter, for the sake of convenience, the CID value is assumed to be assigned according based on an amount of energy.

The SA-GID is group (cluster) identification (ID) information for grouping normal nodes based on their sensor attributes, and is assigned according to the sensing attribute of s normal node so that the normal node is included in one of the normal node clusters 2, 4, and 6. For example, the SA-GID is given to a specific node so that the normal node is included in one of the first normal node cluster 2 in which the specific node checks temperature, the second normal node cluster 4 in which the specific node checks humidity, and the third normal node cluster 6 in which the specific node checks movement. The same SA-GID is given to normal nodes within the same cluster.

The SA-ID is identification information of each normal node in the normal node clusters 2, 4, and 6. Therefore, normal nodes in the same group have different SA-IDs. The payload is a portion where predetermined data is stored. And, the CRC is a portion including an error code for detecting errors in transmitted data.

FIG. 3 is a flowchart of a process of automatically selecting a cluster header from normal nodes included in a normal node cluster according to an exemplary embodiment of the present invention.

Referring to FIG. 3, when a cluster header is dismissed for some reason, first, the sink node 10 provides a header selecting signal to the normal nodes so that a cluster header is automatically selected. Corresponding normal nodes are supplied with the header selecting signal and broadcast a CPDU to neighboring normal nodes. Subsequently, each normal node selects a cluster header using the received CPDU.

Specifically, first, a specific normal node checks whether CPDU data is received from other normal nodes (S20). When CPDU data is received in step S20, a first timer is initialized (S22). Here, the first timer is included in each normal node and used for checking the time when CPDU data is input.

After the first timer is initialized in step S22, the specific normal node extracts a CID value from the received CPDU data (S24) and compares the extracted CID value with its own CID value (S26 and S28). When the received CID value is determined to be smaller than its own CID value in step S28, the specific normal node extracts an SA-GID value from the received CPDU data (S30) and determines whether the extracted SA-GID value and its own SA-GID value are the same (S32).

When the SA-GID value of the specific normal node and the extracted SA-GID value are determined to be the same in step S32, the specific normal node initializes a second timer (S34) and stops broadcasting CPDU data (S36). When the broadcasting of CPDU data is stopped in step S36, the specific normal node is left out of the cluster header selecting process.

In other words, when a CID value received from another normal node is determined to be smaller than the CID value of the specific normal node in step S28, there is another normal node having higher energy than the specific normal node. And, when the received SA-GID and the SA-GID of the specific normal node are determined to be the same in step S32, there is another normal node having higher energy than the specific normal node in the same normal node group. Therefore, the specific normal node, having less remaining energy than another normal node included in a same normal node group, is left out of the cluster header selecting process. Here, it is assumed that CID values are assigned according to the remaining amount of energy, however the same process can be applied to other cases in which CID values are assigned based on hardware capability or some other properties.

Meanwhile, when the SA-GID value of the specific normal node and the extracted SA-GID value are determined to be not the same in step S32, the specific normal node checks a predetermined time using the second timer (S38). While the predetermined time is checked by the second timer, the specific normal node checks if CPDU data is received (S40). When CPDU data is received in step S40, the second timer is initialized (S41). Then, the specific normal node repeats the process starting from step S22. Meanwhile, when CPDU data is not received while the predetermined time is checked by the second timer, the specific normal node is selected as a cluster header (S42 and S44).

In other words, when the SA-GID value of the specific normal node and the received SA-GID value are determined to be not the same in step S32, another normal node supplying CPDU data and the specific normal node receiving the CPDU data are included in mutually different normal node groups. And, when CPDU data is not received while the predetermined time is checked by the second timer, the specific normal node is regarded as a unique node in a normal node group including the specific normal node, and thus is selected as a cluster header.

Meanwhile, when the extracted CID value is determined to be smaller than the CID value of the specific normal node in step 28, the specific normal node does not broadcast but rather scraps the received CPDU data (S46). Specifically, since a remaining energy amount of another node which supplied the CPDU data is determined to be smaller than that of the specific normal node, the specific normal node scraps the CPDU data and returns to step S20.

When CPDU data is not received in step S20, the specific node checks a predetermined time using the first timer (S48). When CPDU data is not received for a predetermined time period in step S48, the specific normal node is selected as a cluster header (S50 and S44). In the present invention, the smaller a CID value of a node, the greater the chance of the node to be selected as a cluster header. As a matter of fact, according to the present invention, the smaller the CID value, the higher the priority for being a cluster header and the greater the number of chances given, so that at least one cluster header is selected from each group of normal nodes. And, according to the present invention, when only one normal node is included in a specific normal node group, the normal node is selected as a cluster header.

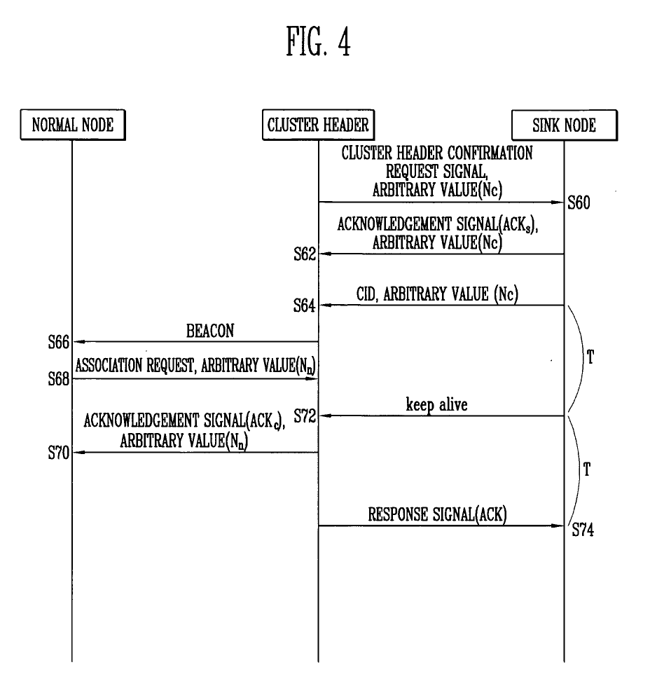

FIG. 4 shows a process of configuring a wireless sensor network after a cluster header is selected according to an exemplary embodiment of the present invention.

Referring to FIG. 4, first, the cluster header selected through the process shown in FIG. 3 sends a cluster header confirmation request signal and an arbitrary value (nonce (Nc)) to the sink node (S60). Here, the confirmation request signal includes a CPDU value, and the arbitrary value Nc is set up as a random value that cannot be estimated to certify a message of the sink node. And, the cluster header encodes the confirmation request signal and the arbitrary value Nc with a shared master key, and sends the encoded confirmation request signal and the encoded arbitrary value Nc.

The sink node receives the confirmation request signal and the arbitrary value Nc, and then encodes an acknowledgment signal ACKs signaling acceptance of a cluster header, and the arbitrary value Nc, with the master key and sends the encoded acknowledgment signal ACKs and the encoded arbitrary value Nc to the cluster header (S62). And, the sink node stores and manages information (CPDU and the arbitrary value Nc) of the cluster header. After step S62, the sink node unicasts a CID value of a previously selected cluster header and the arbitrary value Nc to all cluster headers (S64). Thus, each cluster header stores a CID value of another cluster header and the arbitrary value Nc in its local storage.

The cluster header is supplied with the acknowledgment signal ACKs from the sink node and provides network information to the normal nodes using a beacon signal (S66). Each normal node receives the beacon signal; encodes an association request signal and an arbitrary value Nn with the master key; and sends the encoded association request signal and encoded arbitrary value Nn to the cluster header (S68). Here, a SA-ID and the arbitrary value Nn of each normal node included in the association request signal is stored in the cluster header and managed. Subsequently, the cluster header encodes an acknowledgment signal ACKc and the arbitrary value Nn with the master key and sends the encoded acknowledgment signal ACKc and the encoded arbitrary value Nn to each normal node (S70). Thereby, the sensor network with the normal nodes is formed centering on the cluster header.

Meanwhile, the sink node sends a keep alive signal to the cluster header after a predetermined time T (S72). Then, the cluster header sends a response signal ACK to the sink node within the predetermined time T (S74). Actually, the sink node and cluster header repeatedly send the keep alive signal and the response signal at predetermined time intervals, and check whether there is a problem in the sensor network or not. When the response signal ACK is not supplied from the cluster header within the predetermined time T, the sink node broadcasts the header selecting signal to the normal nodes so that a cluster header is selected from the normal nodes through the process shown in FIG. 3.

FIG. 5 shows an encrypted communication method between a normal node and a cluster header according to an exemplary embodiment of the present invention. Referring to FIG. 5, for communication between a normal node and a cluster header, an encryption key, a message authentication code (MAC) key, and so forth are used. The encryption key is calculated by performing the Hash function on the master key shared by the entire wireless network and a normal node identification (SA-ID) value (K_{E}=HASH(Kₘₐₛₜₑᵣ, SA-ID)). Here, the encryption key is used for encoding data. In this case, since a SA-ID is used for generating the encryption key, a different encryption key is generated for each normal node. And, the MAC key is calculated with the arbitrary value Nn opened by a normal node during the association request process described above (MAC(K_{Nn},C)). Here, the MAC key is used for certifying a normal node at a cluster header.

Meanwhile, the encryption key and the MAC key are calculated by functions having a one-way characteristic, thus enabling secure communication between a normal node and cluster header. After the encryption key and the MAC key are generated, data is encoded using a symmetric key encryption algorithm such as the data encryption standard (DES) and the RC5, and sent from a normal node to the cluster header (C=P<K_{E}>, MAC(K_{Nn},C)).

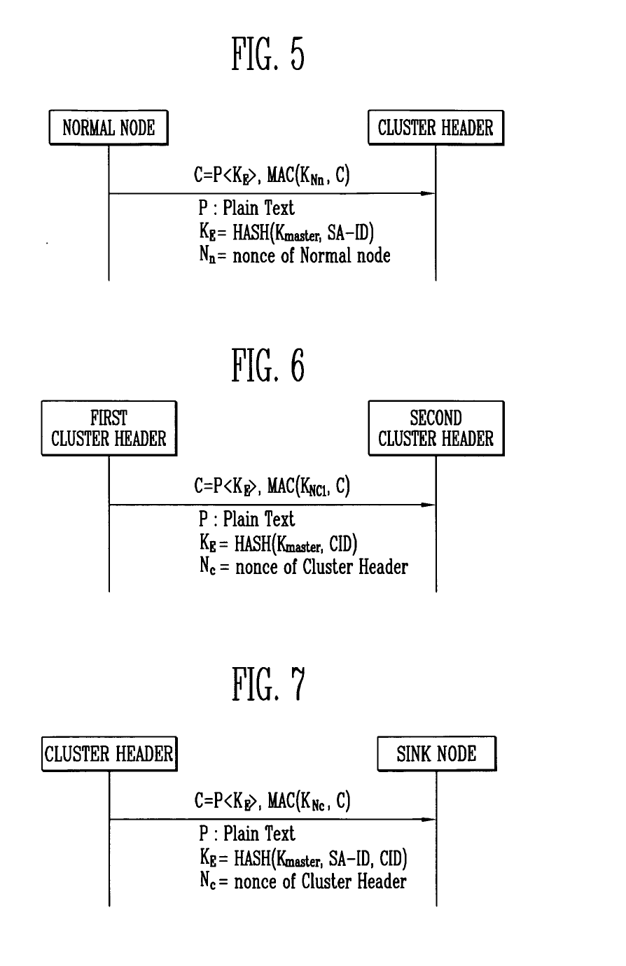

FIG. 6 shows an encrypted communication method between cluster headers according to an exemplary embodiment of the present invention.

Referring to FIG. 6, an encryption key, a MAC key, and so forth are used for communication between cluster headers. The encryption key is calculated by the Hash function of the shared master key and a CID key (K_{E}=HASH(Kₘₐₛₜₑᵣ, CID)). Here, as described in step S64 of FIG. 4, a cluster header stores CIDs of other cluster headers. The encryption key is used for encoding data.

The MAC key is calculated with the arbitrary value Nc sent to the sink node during the configuring process of the wireless sensor network. As described in step S64 of FIG. 4, a cluster header stores the arbitrary value Nc of other cluster headers. The MAC key is used for certifying a cluster header. Meanwhile, the encryption key and the MAC key are calculated by using a function having a one-way characteristic, thus enabling secure communication between cluster headers. After the encryption key and the MAC key are generated, data is encoded using a symmetric key encryption algorithm such as data encryption standard (DES) and RC5, and sent from a first cluster header to a second cluster header (C=P<K_{E}>, MAC(K_{Ncl},C)).

FIG. 7 shows an encrypted communication method between a cluster header and a sink node according to an exemplary embodiment of the present invention. Referring to FIG. 7, an encryption key and a MAC key are used for communication between the cluster header and the sink node. The encryption key is calculated as the Hash function of the shared master key and CID and SA-GID of the cluster header (K_{E}=HASH(Kₘₐₛₜₑᵣ, SA-GID, CID)). The sink node stores CID and SA-ID values of all the clusters supplied in step S60 to decode an encryption key supplied from a cluster header. The encryption key is used for encoding data.

The MAC key is calculated with the arbitrary value Nc sent to the sink node during the configuring process of the wireless sensor network. (MAC(K_{NC}, C)). The sink node stores the arbitrary value Nc of cluster headers received in step S60 to certify a MAC key supplied from a cluster header. Meanwhile, the encryption key and the MAC key are calculated by functions having a one-way characteristic to thus enable secure communication between a cluster header and the sink node. After the encryption key and the MAC key are generated, data is encoded using a symmetric key encryption algorithm such as data encryption standard (DES) and RC5, and sent from the cluster header to the sink node (C=P<K_{E}>, MAC(K_{NC},C)).

As described above, in the wireless sensor network system and method of configuring the same according to the present invention, since a cluster header is automatically selected from normal nodes when a cluster header is dismissed (due to exhausted energy or physical environment), it is possible to automatically reconfigure the wireless sensor network. Here, a cluster header is automatically selected considering a remaining energy amount, hardware capability, or some other property, and thus the network can stably operate. In addition, the present invention provides the method of encrypted communication between respective nodes of the wireless sensor network, and therefore can be trusted as safe.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for selecting a cluster header in a node cluster including at least one normal node, comprising the steps of:
broadcasting, at each normal node, cluster header selecting information including capability information of the normal node, identification information of a cluster that the normal node belongs to, and identification information of the normal node, to neighboring nodes; and
determining, at each normal node, if the normal node will be selected as a cluster header using the cluster header selecting information received from at least one neighboring node.

2. The method according to claim 1, wherein the capability information is set up based on at least one of an amount of remaining energy, hardware capability, and an energy consumption amount.

3. The method according to claim 1, wherein the step of determining at each normal node, includes:
(i) detecting whether or not the cluster header selecting information is received from the neighboring nodes;
(ii) initializing a first timer after the cluster header selecting information is received;
(iii) comparing its capability information with capability information of the neighboring nodes included in the received cluster header selecting information;
(iv) returning to the step (i) when the capability information of the normal node is determined to be higher than those of the neighboring nodes in the step (iii); and
(v) determining itself as a cluster header when the cluster header selecting information is not received from the neighboring nodes during a predetermined time checked by the first timer.

4. The method according to claim 3, further including the steps of: when the capability information of the normal node is determined to be lower than those of the neighboring nodes in the step (iii),
(vi) extracting the cluster identifying information from the received cluster header selecting information;
(vii) initializing a second timer when the extracted cluster identifying information value is determined to be the same as the cluster identifying information value of the normal node; and
(viii) stopping broadcasting of the cluster header selecting information of the normal node.

5. The method according to claim 4, further including the steps of:
(ix) checking a predetermined time with the second timer when the extracted cluster identifying information is determined to be different from the cluster identifying information of the normal node; and
(x) determining itself as a cluster header when the cluster header selecting information is not received from the neighboring nodes during the predetermined time checked by the second timer.

6. The method according to claim 5, further including the step of initializing the second timer and returning to the step (ii), when the cluster header selecting information is received from the neighboring nodes during the predetermined time checked by the second timer.

7. A method for configuring a wireless sensor network system, comprising:
(i) selecting a cluster header from a node cluster including at least one normal node;
(ii) sending a cluster header confirmation request signal including capability information of the cluster header and a first random value from the cluster header to a sink node;
(iii) sending a cluster header acknowledgement signal and the first random value from the sink node to the cluster header;
(iv) sending a beacon signal from the cluster header to the normal node;
(v) sending an association request signal including the identification information of the normal node and a second random value from the normal node to the cluster header; and
(vi) sending an association acknowledgement signal and the second random value from the cluster header to the normal node.

8. The method according to claim 7, further comprising:
when there is a plurality of node clusters connected to the sink node, performing the steps of (i) to (vi) for each of the node clusters and sending selecting information of other cluster headers and the first random value to each cluster header selected from each of the node clusters.

9. The method according to claim 7, further comprising:
periodically supplying a keep alive signal from the sink node to the cluster header; and
sending a response signal from the cluster header to the sink node.

10. The method according to claim 9, wherein when the response signal is not sent from the cluster header in response to the keep alive signal within a predetermined time, the sink node supplies a cluster header selecting signal to the normal node.

11. The method according to claim 7, wherein after the wireless sensor network system is configured, encrypted communication is performed among the normal node, the cluster header, and the sink node.

12. The method according to claim 11, wherein the encrypted communication between the normal node and the cluster header includes:
calculating an encryption key with the identification value of the normal node and a shared master key; and
calculating a message authentication code (MAC) key, which is used for certifying a message, with the second value of the normal node.

13. The method according to claim 11, wherein the encrypted communication between the cluster headers includes:
calculating an encryption key with the capability information of each cluster header and a shared master key; and
calculating a message authentication code (MAC) key, which is used for certifying a message, with the first value of each cluster header.

14. The method according to claim 11, wherein the encrypted communication between the cluster header and the sink node includes:
calculating an encryption key with the capability information and the identification information of the cluster header and a shared master key; and
calculating a message authentication code (MAC) key, which is used for certifying a message, with the first value of the cluster header.
